(19) United States
(12) Patent Application Publication
(10) Pub. No.: US 2010/0132244 A1
(43) Pub. Date: Jun. 3, 2010

(54) Rodent Trap

(76) Inventor: Edward J. Ridge, Winnipeg (CA)

Correspondence Address: ADE & COMPANY INC., 2157 Henderson Highway, WINNIPEG, MB, R2G1P9, CA

(21) Appl. No.: 12/471,533

(22) Filed: May 26, 2009

Related U.S. Application Data
(60) Provisional application No. 61/056,629, filed on May 28, 2008.

(51) Int. Cl. A01M 23/10; A01M 23/04

(52) U.S. Cl. 43/71; 43/74; 43/124

(57) ABSTRACT

A rodent trap comprises a pail having an upright side wall extending upwardly from a bottom wall to an open top end of the pail. A rotating body is supported for rotation at the open top end of the pail. Typically a ramp provides rodent access to bait on the rotating body. In a preferred embodiment, a pair of integrally moulded mounting grooves on an inner surface of the side wall retain opposing ends of a shaft of the rotating body such that the shaft is slidably removable from the grooves through the open top end of the pail, and the outer surface of the rotating body includes at least one groove formed therein so as to be arranged to receive and retain bait therein.

This application claims the benefit under 35 U.S.C. 119(e) of U.S. provisional application Ser. No. 61/056,629, filed May 28, 2008.

### FIELD OF THE INVENTION

The present invention relates to a rodent trap of the type supporting a baited rotating body above a pail in which rodent access is provided to the rotating body, for example by a ramp.

### BACKGROUND

A known configuration of rodent trap comprises a pail supporting a rotating body thereabove in which bait, for example in the form of peanut butter and the like can be applied to the rotating body. Rodent access is provided to the rotating body by a ramp. When the rodent steps on the rotating body to access the bait, the body rotates so that the rodent falls into the pail. Liquid can be provided in the pail to drown the rodent.

Examples of rodent traps supporting a rotating body above a pail are described in the following US patents: U.S. Pat. No. 3,528,191 belonging to Hand, U.S. Pat. No. 5,528,852 belonging to Sarff, U.S. Pat. No. 2,619,765 belonging to Sees, U.S. Pat. No. 5,996,274 belonging to Smith et al. and U.S. Pat. No. 5,517,784 belonging to Sedore.

Typically the construction of a rodent trap supporting a rotating body above a pail requires specially made clamps for attachment to the pail to support the ramp or the rotating body or both which considerably increases the cost of the overall trap. Furthermore the setup of the prior art configurations typically requires a sufficiently large setup space to accommodate an elongate ramp extending outward form the pail.

### SUMMARY OF THE INVENTION

According to one aspect of the invention there is provided a rodent trap comprising:

a pail comprising:
a bottom wall;
an upright side wall extending upwardly from a periphery of the bottom wall to an open top end of the pail;
a rim extending about the open top end which includes a depending portion extending downwardly from the top end of the pail to a lower free edge spaced radially outward from the upright side wall; and
a pair of mounting apertures formed at diametrically opposed locations in the upright side wall above the lower free edge of the rim;

a shaft supported at opposing ends in the pair of mounting apertures respectively; and

a rotating body supported on the shaft for rotation relative to the pail at a location spaced above the bottom wall of the pail adjacent the open top end of the pail; and

a ramp engageable with the rim of the pail and arranged to provide rodent access to the rotating body.

By providing a pail with a depending portion on the rim, simple apertures in the pail are sufficient to retain a shaft mounted on the pail by receiving the shaft through the apertures and centrally retaining the location of the shaft using the depending portion of the rim against which the opposing ends of the shaft may be substantially abutted. Accordingly no special clamps are required to be manufactured to reduce the overall cost of the trap.

The shaft preferably comprises a single integral member which is continuous between the opposing ends thereof and preferably has a length which is near an inner diameter of the depending portion of the rim.

The rotating body may be slidably mounted onto the shaft and centrally fixed on the shaft by a pair of clamps on the shaft.

The ramp may include: i) first and second portions arranged to be foldable relative to one another; and ii) a protrusion projecting generally perpendicularly outward from a bottom side of the ramp adjacent one end of the ramp which is arranged to be received in a mating aperture formed in the rim of the pail.

According to a second aspect of the present invention there is provided a rodent trap comprising:

a pail having a bottom wall and an upright side wall extending upwardly from a periphery of the bottom wall to an open top end of the pail;

a rotating body supported for rotation relative to the pail at a location spaced above the bottom wall of the pail adjacent the open top end of the pail; and

a ladder structure supported along an external surface of the side wall of the pail from the bottom wall to the open top end so as to be arranged to provide rodent access to the rotating body.

When providing a ladder structure on the external surface of the pail, no ramp structure is required so that the resulting set up rodent trap occupies minimal space as compared to prior art configurations requiring an elongate ramp extending outwardly from the pail.

The ladder structure may comprise a generally cylindrical member formed of rigid mesh material arranged to extend about a full circumference of the side wall of the pail so as to concentrically receive the pail slidably therein such that the pail remains selectively separable from the ladder structure. There may be provided a handle formed on the pail adjacent the top end thereof projecting upwardly from the ladder structure for grasping with a hand of a person to slidably remove the pail from the ladder structure.

In an alternative embodiment, the ladder structure may be integrally formed on the external surface of the side wall of the pail.

According to another aspect of the present invention there is provided a rodent trap comprising:

a pail having a bottom wall and an upright side wall extending upwardly from a periphery of the bottom wall to an open top end of the pail;

a rotating body supported for rotation relative to the pail at a location spaced above the bottom wall of the pail adjacent the open top end of the pail; and

a climbing structure arranged to extend between a supporting surface receiving the bottom wall of the pail thereon and the top end of the pail so as to be arranged to provide rodent access to the rotating body by climbing the climbing structure;

the rotating body having a generally cylindrical outer surface supported for rotation about a generally horizontal axis of rotation adjacent the open top end of the pail, the outer surface of the rotating body including at least one groove formed therein so as to be arranged to receive bait therein.

There may be provided a plurality of grooves extending generally in a direction of the axis of rotation at circumferentially spaced positions about the outer surface.

The outer surface of the rotating body preferably includes a plurality of ridges extending axially between opposing ends of the rotating body, each groove being defined between an adjacent pair of the ridges.

According to another aspect of the present invention there is provided a rodent trap comprising:

a pail having a bottom wall and an upright side wall extending upwardly from a periphery of the bottom wall to an open top end of the pail;

a rotating body supported for rotation relative to the pail at a location spaced above the bottom wall of the pail adjacent the open top end of the pail;

a pair of mounting grooves integrally formed at diametrically opposed locations on an inner surface of the upright side wall, each groove extending generally vertically downward from the open top end of the pail to a terminal bottom end of the groove in proximity to the open top end of the pail;

an axle spanning diametrically across the open top end of the pail between opposing ends which are received in respective ones of the mounting grooves, the axle supporting the rotating body centrally thereon for rotation about a generally horizontal axis of the axle;

the opposing ends of the axle being supported on the bottom ends of the respective grooves such that the axle is slidably removable from the mounting grooves through the open top end of the pail;

each of the grooves being enclosed along an outer side of the upright side wall so as to be arranged to retain the opposing ends of the axle in a direction of the axis of the axle; and

a climbing structure arranged to extend between a supporting surface receiving the bottom wall of the pail thereon and the top end of the pail so as to be arranged to provide rodent access to the rotating body by climbing the climbing structure.

The mounting grooves are preferably integrally moulded into the upright side wall of the pail.

When the climbing structure comprises a ramp engageable with the rim of the pail and preferably the upright side wall includes a recess integrally formed in a peripheral rim at the open top end of the pail arranged to receive the top end of the ramp therein.

There may be provided a first mating connector integrally formed in the recess on the peripheral rim of the pail and a second mating connector integrally formed on the ramp adjacent the top end thereof in which the first and second connectors are arranged for mating connection to selectively retain the top end of the ramp engaged in the recess.

When the climbing structure comprises a ramp engageable with the rim of the pail in which the ramp is elongate in a longitudinal direction between a top end and a bottom end of the ramp and in which the ramp comprises a lower portion spanning between the bottom end of the ramp and a first mating connector integrally molded on an end of the lower portion opposite the bottom end of the ramp and an upper portion spanning between the top end of the ramp and a second mating connector integrally molded on an end of the upper portion opposite the top end of the ramp, preferably the first and second mating connectors are arranged to be coupled in mating engagement with one another for relative sliding movement in a lateral direction perpendicular to the longitudinal direction of the ramp between an engaged position and a released position of the upper and lower portions of the ramp.

When the rotating body has a generally cylindrical outer surface supported for rotation about a generally horizontal axis of rotation adjacent the open top end of the pail, the outer surface of the rotating body preferably includes at least one groove formed therein so as to be arranged to receive bait therein.

Some embodiments of the invention will now be described in conjunction with the accompanying drawings in which:

### BRIEF DESCRIPTION OF THE DRAWINGS

FIG. 1 is a top plan view of a first embodiment of the rodent trap.

FIG. 2 is a sectional view along the line 2-2 of FIG. 1.

FIG. 3 is a sectional view along the line 3-3 of FIG. 1.

FIG. 4 is a perspective view of a further embodiment of the rodent trap.

FIG. 5 is a top plan view of the rodent trap according to FIG. 4.

FIG. 6 is a sectional view along the line 6-6 of FIG. 5.

FIG. 7 is a perspective view of a further embodiment of the rodent trap.

FIG. 8 is an exploded perspective view of the ramp according to FIG. 7.

FIG. 9 is an end elevational view of the rotating body according to the embodiment of FIG. 7.

In the drawings like characters of reference indicate corresponding parts in the different figures.

### DETAILED DESCRIPTION

Referring to the accompanying figures there is illustrated a rodent trap generally indicated by reference numeral 10. The rodent trap 10 uses bait to attract rodents so that the rodents can be trapped and exterminated. Although various embodiment of the trap are described in the following, the common features of the various embodiments will first be described herein.

In each instance the trap comprises a pail 12 having a flat bottom wall 14 arranged to be supported on a horizontal supporting surface. The bottom wall 14 is typically round having a circular peripheral edge. An upright side wall 16 extends upwardly from the peripheral edge of the bottom wall 14 about a full circumference of the bottom wall to a top end 18 of the pail. A top edge of the upright side wall 16 is generally circular about the open top end 18 of the pail to define a circular opening lying generally in a horizontal plane spaced above the bottom wall 14.

A shaft 20 is mounted at opposing ends at diametrically opposite locations on the upright side wall 16 of the pail at a location spaced above the bottom 14 of the pail and adjacent the open top end 18.

A cylindrical body 22 is supported centrally on the shaft so as to be concentric with the shaft for rotation relative to the pail about a horizontal axis of the shaft. The cylindrical body 22 is slidably mounted onto the shaft and retained centrally thereon by suitable clamps 24 supported about the shaft 20 at opposing ends of the cylindrical body 22. The cylindrical body has a length in the axial direction which is smaller than the diameter of the pail at the open top end so that both ends of the cylindrical body are spaced inwardly from the respective mounting locations on the upright side wall 16 which support the opposing ends of the shaft 20. The cylindrical body 22 has a smooth rigid surface which provides no opportunity for rodents to grip the body when the body rotates.

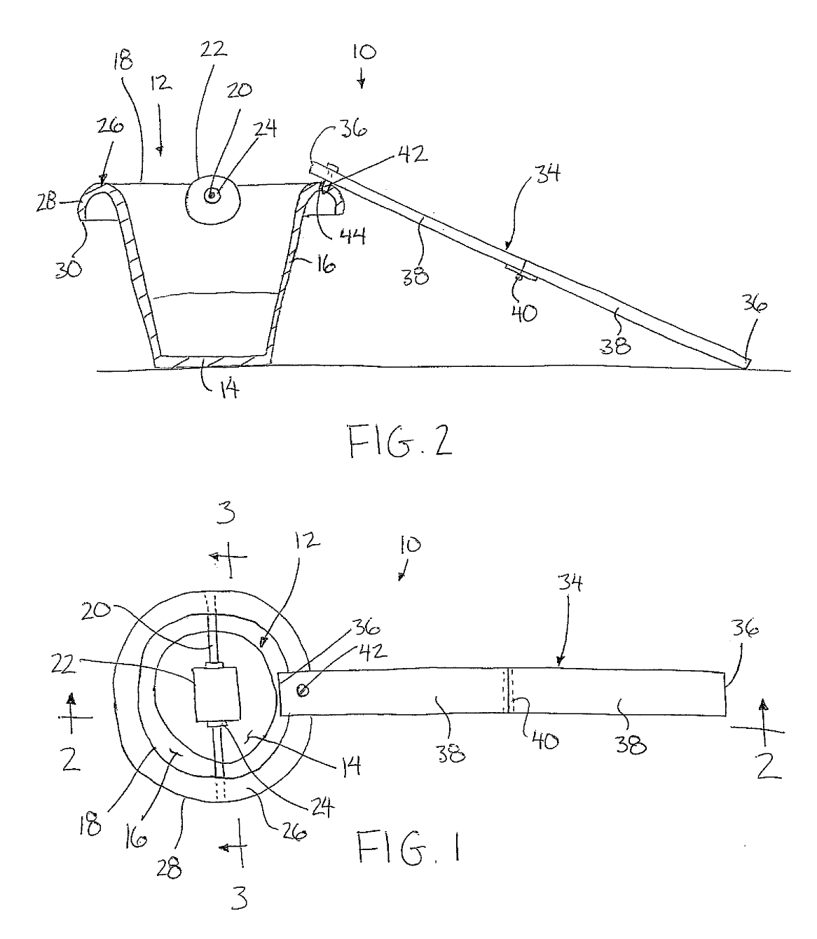

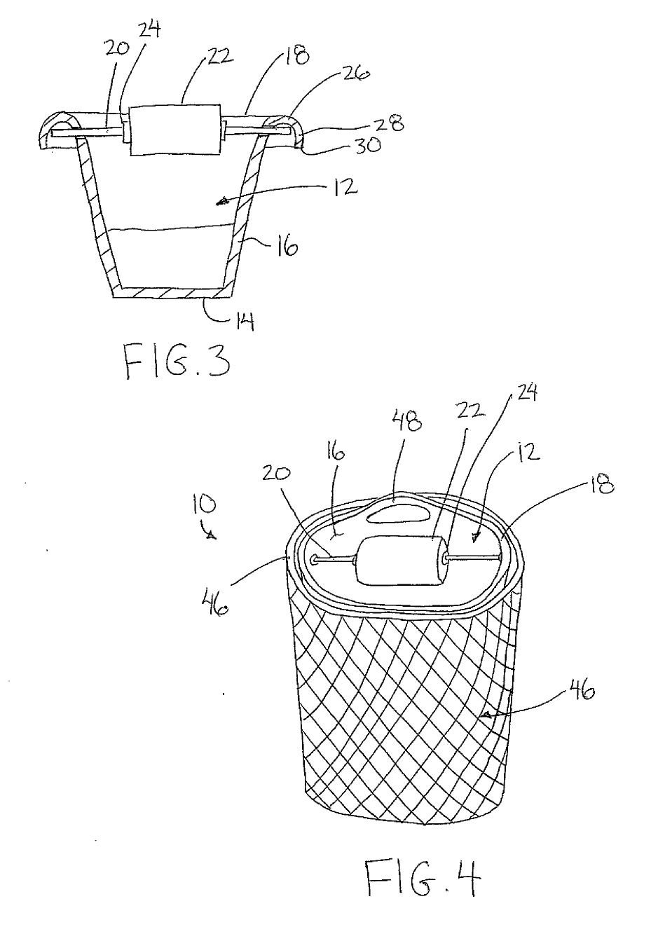

Turning now to FIGS. 1 through 3, the first embodiment will now be described in further detail. According to the first embodiment the pail includes a rim 26 extending radially outward from the top edge 18 of the upright side wall to a depending portion 28 of the rim which extends downwardly from the top end of the pail to a lower free edge 30 spaced radially outward from the upright side wall 16 and spaced downwardly from the top end of the pail about a full circumference of the upright side wall to define an annular gap between the upright side wall and the depending portion 28 of the rim.

The diametrically opposed mounting locations of the shaft 20 in this instance comprise mounting apertures 32 which are located in the upright side walls to be above a height of the lower free edge 30 of the depending portion in horizontal alignment with the gap between the side wall 16 and the depending portion 28 of the rim. The two mounting apertures 32 are equidistant from the bottom wall of the pail so as to be at the same height such that mounting of the shaft 20 at opposing ends in the two mounting apertures 32 respectively causes the shaft to be supported horizontally across the pail.

The shaft is arranged to have a length which is greater than an inner diameter of the pail at the open top end so as to be less but near in diameter to the inner diameter of the depending portion 28 of the rim. Accordingly when the shaft is received through the diametrically opposed mounting apertures 32 the opposing ends of the shaft are substantially abutted against the inner surface of the depending portion 28 of the rim at diametrically opposed locations to centrally retain the shaft in position relative to the pail without any auxiliary clamps or retaining mechanisms being required. The shaft is thus suitably arranged to substantially span the gap between the upright side wall 16 and the depending portion 28 of the rim at the two opposed ends thereof.

The shaft typically comprises a single integral member which is continuous between the opposed ends thereof. The material of the shaft may be somewhat flexible to allow bending of the shaft during mounting in the respective mounting apertures in the pail, however the shaft is also sufficiently rigid so as to remain rigid and non-flexing under the weight of the rotating body and a rodent potentially supported thereon.

Access is provided to the rotating body by a ramp 34 which is elongate in a longitudinal direction between two opposed ends 36 of the ramp. The ramp is formed in two portions 38 each extending in the longitudinal direction approximately half a length of the overall ramp in which the two portions 38 are joined in an end to end configuration in the longitudinal direction by a central hinge 40 which permits the two portions of the ramp to be foldable relative to one another between an in use position in which the two portions of the ramp are substantially coplanar and a storage position in which the two portions of the ramp are substantially alongside one another.

The ramp is supported on the pail by a protrusion 42 extending perpendicularly outward from a bottom side of the ramp adjacent one end thereof. The protrusion 42 typically comprises a screw which is fastened through the ramp surface from the top side to project downwardly from the bottom side of the ramp when assembled. The protrusion 42 is arranged to mate with a ramp aperture 44 formed in the top surface of the rim 26 of the pail to locate an upper end of the ramp relative to the pail so that ramp remains engaged on the pail, again without any special clamps or special manufactured components being required.

The rodent trap according to the first embodiment is packaged so that the ramp is folded and inserted into the pail. Setting up the trap requires the ramp to be initially removed from the pail and unfolded with the protrusion at one end of the ramp being inserted into the mating ramp aperture in the ramp to support the ramp engaged on the pail. A volume of fluid in the range of one to two litres for example can be inserted into the pail such that the level of the fluid in the pail is near or slightly less than half of the height of the pail. Bait is then placed about the outer surface of the rotating body such as peanut butter, or a spreadable cheese product for example. The trap is then placed in a location where rodents are expected. The rodents will climb the ramp seeking the bait and upon stepping from the ramp to the rotating body the rotating body will rotate so that the rodent falls into the fluid at the bottom of the pail. The fluid may comprise water, or in colder climates an automotive antifreeze product for example.

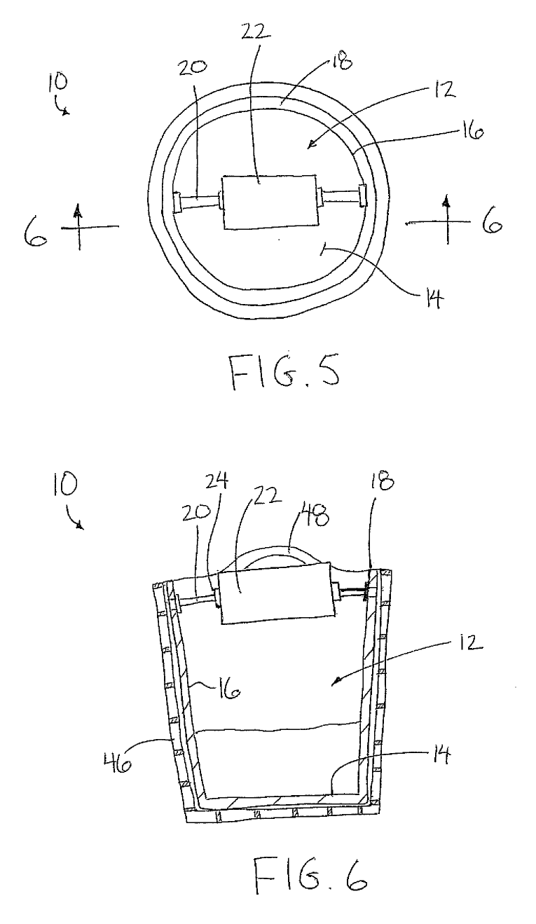

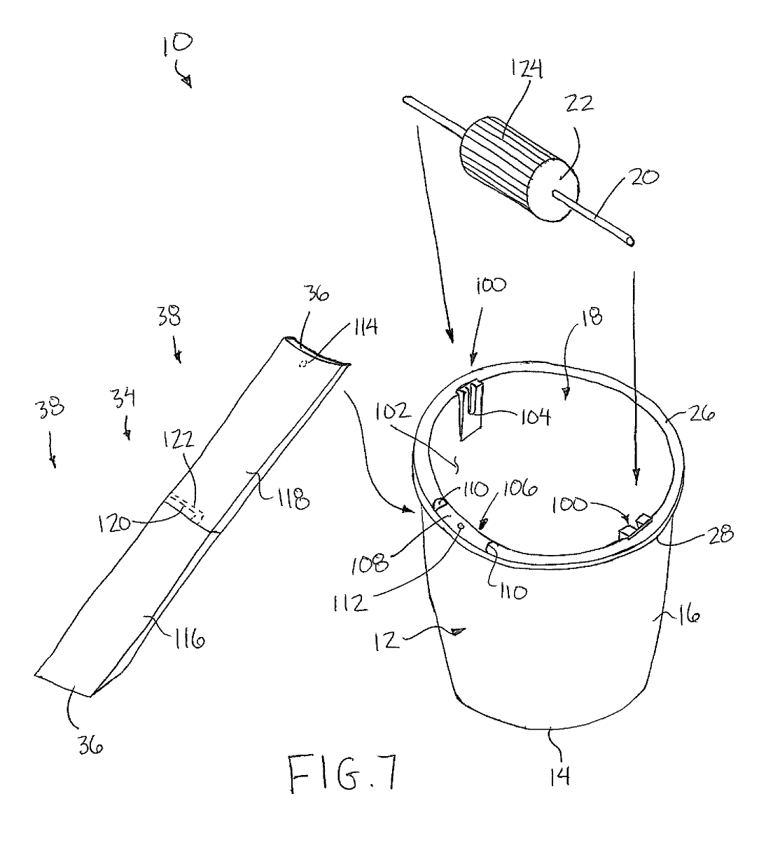

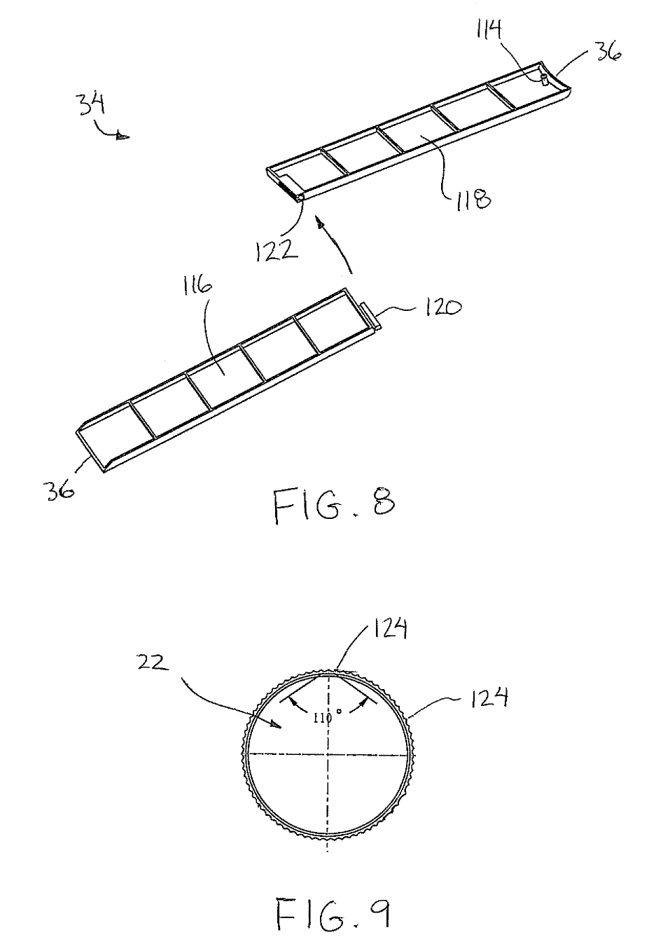

Turning now to FIGS. 4 through 6, the second embodiment of the rodent trap will not be described in further detail. According to the second embodiment the ends of the shaft 20 are supported at diametrically opposed locations adjacent a top end of the pail by various means including apertures which receive the opposing ends of the shaft or various clamp configurations and the like.

In the second embodiment an outer bucket 46 receives the pail 12 slidably therein. The outer bucket 46 comprises a cylindrical wall of a rigid mesh material having a height which spans substantially the height of the pail along the upright side wall 16 thereof from the bottom wall 14 to the open top end 18. The rigid mesh of the cylindrical wall of the outer bucket 46 extends about a full circumference of the pail to full surround the pail about 360 degrees thereof. The rigid mesh material of the outer bucket 46 provides a suitable texture for gripping and climbing by rodents to define a ladder structure extending upwardly alongside the upright side wall 16 of the pail. The pail 12 slidably fits in close proximity to the inner diameter of the outer bucket 46 so as to remain selectively separable therefrom. A handle portion 48 extends upwardly from the top edge of the pail about part of the circumference of the pail in which a suitable aperture is formed in the handle portion to provide access to a hand of a person to grip the pail and pull the pail upward relative to the outer bucket for separating the pail from the bucket if desired.

Similar to the previous embodiment, fluid is placed in the pail 12 for purposes of drowning rodents which fall into the pail. Bait in the form of peanut butter or a spreadbly cheese product for example are similarly provided in a band about a center of the cylindrical body. Also similar to the previous embodiment the trap must be periodically checked to dump the contents of trapped rodents therein and to replace the fluid in the pail as well as the bait on the cylindrical body as required. In use rodents can smell the bait on the cylindrical body and will climb up the ladder structure defined by the mesh material of the outer bucket 46 up to the open top end of the pail. When the rodents step onto the rotating body from the top edge of the outer bucket 46 the cylindrical body will rotate so that the rodents quickly fall into the pail and drown as in the previous embodiment.

In further embodiments the ladder structure may be integrally formed on the external surface of the pail 12 by intergrally molding texture on the external surface of the bucket which is suitable for griping and climbing by rodents to provide rodent access from the bottom wall of the pail to the top edge along the external surface thereof to access the rotating body. In all embodiments the inner surface of the pail remains smooth to prevent rodents from climbing back out of the pail once having fallen into the pail from the rotating body.

Turning now to the embodiments of FIGS. 7 through 9, the trap 10 again comprises a pail 12 having a bottom wall 14 and an upright side wall 16 which is generally cylindrical and which extends upwardly from the bottom wall to the open top end 18 as in the previous embodiments. A similar peripheral rim 26 with a depending portion 18 is also provided. The shaft or axle 20 in this instance is secured at opposing ends within respective integrally moulded mounting grooves 100 formed at diametrically opposite sides in the inner surface 102 of the upright side wall 16. As in the previous embodiment, a rotating body 22 having a generally cylindrical outer surface is again supported centrally on the axle 20 for access by rodents by a similar climbing structure such as a ramp 34 which is elongate in a longitudinal direction between opposing ends 36 as in the pervious embodiments. The ramp 34 according to FIGS. 7 through 9 again comprises two portions 38 which are centrally joined with one another.

The mounting grooves 100 formed in the diametrically opposed sides of the inner surface 102 each extend vertically between an open top end at the open top end of the pail 12 and a terminal bottom end 104 defining a horizontal shoulder in close proximity to the top end but spaced below the top end of the groove to support a respective end of the axle 20 thereon. Each of the grooves is enclosed at the outer side of the upright side wall 16 such that the opposing ends of the axle are engaged between the enclosed outer sides of the grooves to be retained in the axial direction therebetween. When the opposing ends of the axle 20 are engaged upon the respective terminal bottom ends 104 of the two mounting grooves, the axle spans generally horizontally across the top end of the pail spaced below the height of the rim by a distance which is substantially equal to or less than the radius of the rotor body such that an upper surface of the rotor body in the in use position is near or above the height of the peripheral rim at the open top end of the pail when the axle is spaced below the top end on the terminal bottom ends 104 of the respective grooves.

The pail 12 according to FIG. 7 also includes a mounting recess 106 formed in the peripheral rim 26 such that a portion of the rim in the circumferential direction corresponding approximately to a width of the ramp 34 in the lateral direction is reduced in height relative to the remainder of the peripheral rim by a distance corresponding to the thickness of the ramp 34 between top and bottom sides thereof. In this instance the top end of the ramp is arranged to be received within the mounting recess 106 so as to be substantially flush at the top side with the top surface of the peripheral rim 26 of the pail. The top end of the ramp which is arranged to be engaged within the mounting recess includes a curved end face which is generally concave so as to match the profile of the inner surface of the pail such that the end face of the ramp is also flush with the inner surface of the pail in the mounted position.

The mounting recess 106 generally comprises a flat bottom face 108 recessed relative to the top of the peripheral rim which spans circumferentially between two upright end walls 110 which retain the width of the ramp at the top end thereof therebetween. A first mating connector 112 is integrally molded into the flat bottom 108 of the recess in the form of a socket or an aperture extending through the flat bottom surface at a central location between the two end walls.

The ramp 34 includes a second mating connector 114 integrally molded on the bottom surface thereof adjacent the top end in the form of a downwardly projecting protrusion which is oriented generally perpendicularly to the bottom face upon which it is mounted. The protrusion forming the second mating connector 114 is arranged for alignment with and to be received within the aperture defining the first mating connector 112 when the top end of the ramp is aligned within the mounting recess 106.

The two portions of the ramp 34 according to the embodiment of FIGS. 7 through 9 comprise a lower portion 116 and an upper portion 118. The lower portion spans in the longitudinal direction between the bottom end of the ramp and an opposing end at a central connection of the ramp between the upper and lower portions. The upper portion similarly spans in the longitudinal direction from the top end towards an opposing end at the central connection with the lower portion.

At the central connection, the lower portion comprises a first mating connector 120 integrally molded on the end of the lower portion. The upper portion 118 similarly comprises a second mating connector 122 at the central connection integrally formed on the end of the upper portion opposite the top end. The second mating connector comprises a keyway which extends in a lateral direction from one side edge of the ramp partway across towards the opposing side to a terminal end of the keyway. The first mating connector 120 comprises a key having a cross section which mates with the keyway and which spans in the lateral direction partway across the end of the lower portion opposite the bottom end. The key is arranged to be slidably engaged within the keyway in the lateral direction which is perpendicular to the longitudinal direction of the ramp between a released position in which the upper and lower portions are separated from one another and an engaged position in which the upper and lower portions are retained in alignment with one another so as to be generally co-planar with one another by the mating engagement between the first and second mating connectors such that an inner end of the key is engaged against the terminal end of the keyway.

The rotating body 22 according to FIGS. 7 through 9 includes a plurality of longitudinally extending ridges 124 formed on the generally cylindrical outer surface of the body such that each of the ridges extends in the axial direction of the axle between opposing ends of the body 22. The ridges 124 are circumferentially spaced from one another such that a spaced between each adjacent pair of ridges comprises a longitudinally extending groove with the grooves extending axially between opposing ends of the body at circumferentially spaced positions from one another.

Each ridge 124 comprises two surfaces extending outwardly from the body 22 towards one another to be joined at an apex where the two surfaces are angularly offset from one another by approximately 110°. The groove between each adjacent pair of apexes is generally concave in profile in which the depth of the groove is approximately equal to the width of the groove to effectively retain bait within the grooves. Suitable bait includes spreadable pastes, for example spreadable cheese or peanut butter and the like. The grooves assist in retaining the bait therein even as multiple rodents engage the rotating body as the ridges prevent the bait from being wiped off of the roller.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A rodent trap comprising:
a pail comprising:
a bottom wall;
an upright side wall extending upwardly from a periphery of the bottom wall to an open top end of the pail;
a rim extending about the open top end which includes a depending portion extending downwardly from the top end of the pail to a lower free edge spaced radially outward from the upright side wall; and
a pair of mounting apertures formed at diametrically opposed locations in the upright side wall above the lower free edge of the rim;
a shaft supported at opposing ends in the pair of mounting apertures respectively; and
a rotating body supported on the shaft for rotation relative to the pail at a location spaced above the bottom wall of the pail adjacent the open top end of the pail; and
a ramp engageable with the rim of the pail and arranged to provide rodent access to the rotating body.

2. The trap according to claim 1 wherein the shaft has a length which is near an inner diameter of the depending portion of the rim.

3. The trap according to claim 1 wherein the shaft comprises a single integral member which is continuous between the opposing ends thereof.

4. The trap according to claim 1 wherein the rotating body is arranged to be slidably mounted onto the shaft and wherein there are provided clamps supported on the shaft arranged to centrally fix the rotating body on the shaft.

5. The trap according to claim 1 wherein the ramp includes a protrusion projecting generally perpendicularly outward from a bottom side of the ramp adjacent one end of the ramp, the protrusion being arranged to be received in a mating aperture formed in the rim of the pail.

6. A rodent trap comprising:
a pail having a bottom wall and an upright side wall extending upwardly from a periphery of the bottom wall to an open top end of the pail;
a rotating body supported for rotation relative to the pail at a location spaced above the bottom wall of the pail adjacent the open top end of the pail; and
a ladder structure supported along an external surface of the side wall of the pail from the bottom wall to the open top end so as to be arranged to provide rodent access to the rotating body by climbing the ladder structure.

7. The trap according to claim 6 wherein the ladder structure is arranged to be selectively separable from the pail.

8. The trap according to claim 6 wherein the ladder structure comprises a rigid mesh material.

9. The trap according to claim 6 wherein the ladder structure extends about a full circumference of the upright side wall of the pail.

10. The trap according to claim 6 wherein the ladder structure comprises a generally cylindrical member formed of rigid mesh material arranged to concentrically receive the pail slidably therein.

11. The trap according to claim 10 wherein there is provided a handle formed on the pail adjacent the top end thereof projecting upwardly from the ladder structure for grasping with a hand of a person to slidably remove the pail from the ladder structure.

12. A rodent trap comprising:
a pail having a bottom wall and an upright side wall extending upwardly from a periphery of the bottom wall to an open top end of the pail;
a rotating body supported for rotation relative to the pail at a location spaced above the bottom wall of the pail adjacent the open top end of the pail; and
a climbing structure arranged to extend between a supporting surface receiving the bottom wall of the pail thereon and the top end of the pail so as to be arranged to provide rodent access to the rotating body by climbing the climbing structure;
the rotating body having a generally cylindrical outer surface supported for rotation about a generally horizontal axis of rotation adjacent the open top end of the pail, the outer surface of the rotating body including at least one groove formed therein so as to be arranged to receive bait therein.

13. The trap according to claim 12 wherein there is provided a plurality of grooves extending generally in a direction of the axis of rotation at circumferentially spaced positions about the outer surface.

14. The trap according to claim 12 wherein the outer surface of the rotating body includes a plurality of ridges extending axially between opposing ends of the rotating body, each groove being defined between an adjacent pair of the ridges.

15. A rodent trap comprising:
a pail having a bottom wall and an upright side wall extending upwardly from a periphery of the bottom wall to an open top end of the pail;
a rotating body supported for rotation relative to the pail at a location spaced above the bottom wall of the pail adjacent the open top end of the pail;
a pair of mounting grooves integrally formed at diametrically opposed locations on an inner surface of the upright side wall, each groove extending generally vertically downward from the open top end of the pail to a terminal bottom end of the groove in proximity to the open top end of the pail;
an axle spanning diametrically across the open top end of the pail between opposing ends which are received in respective ones of the mounting grooves, the axle supporting the rotating body centrally thereon for rotation about a generally horizontal axis of the axle;
the opposing ends of the axle being supported on the bottom ends of the respective grooves such that the axle is slidably removable from the mounting grooves through the open top end of the pail;
each of the grooves being enclosed along an outer side of the upright side wall so as to be arranged to retain the opposing ends of the axle in a direction of the axis of the axle; and
a climbing structure arranged to extend between a supporting surface receiving the bottom wall of the pail thereon and the top end of the pail so as to be arranged to provide rodent access to the rotating body by climbing the climbing structure.

16. The trap according to claim 15 wherein the mounting grooves are integrally moulded into the upright side wall of the pail.

17. The trap according to claim 15 wherein the climbing structure comprises a ramp engageable with the rim of the pail and wherein the upright side wall includes a recess integrally formed in a peripheral rim at the open top end of the pail arranged to receive the top end of the ramp therein.

18. The trap according to claim 17 wherein there is provided a first mating connector integrally formed in the recess on the peripheral rim of the pail and a second mating connector integrally formed on the ramp adjacent the top end thereof, the first and second connectors being arranged for mating connection to selectively retain the top end of the ramp engaged in the recess.

19. The trap according to claim 15 wherein the climbing structure comprises a ramp engageable with the rim of the pail, the ramp being elongate in a longitudinal direction between a top end and a bottom end of the ramp and the ramp comprising a lower portion spanning between the bottom end of the ramp and a first mating connector integrally molded on an end of the lower portion opposite the bottom end of the ramp and an upper portion spanning between the top end of the ramp and a second mating connector integrally molded on an end of the upper portion opposite the top end of the ramp, the first and second mating connectors being arranged to be coupled in mating engagement with one another for relative sliding movement in a lateral direction perpendicular to the longitudinal direction of the ramp between an engaged position and a released position of the upper and lower portions of the ramp.

20. The trap according to claim 15 wherein the rotating body has a generally cylindrical outer surface supported for rotation about a generally horizontal axis of rotation adjacent the open top end of the pail, the outer surface of the rotating body including at least one groove formed therein so as to be arranged to receive bait therein.
